(19) United States
(12) Patent Application Publication
(10) Pub. No.: US 2003/0193645 A1
(43) Pub. Date: Oct. 16, 2003

(54) Combination sight and hearing protection

(76) Inventors: Terry L. Gilmore, Pullman, WV (US); Madge L. Gilmore, Pullman, WV (US); Russell E. Gilmore, Pullman, WV (US)

Correspondence Address: David G Beck, Bingham McCutchen LLp, 3 Embarcadero Center, Suite 1800, San Francisco, CA, 94111, US

(21) Appl. No.: 10/121,850

(22) Filed: Apr. 15, 2002

(51) Int. Cl. G02C 7/02; G02C 1/00

(52) U.S. Cl. 351/158

(57) ABSTRACT

The invention is a combination safety glasses and ear protection. A hearing protector attaches to each side of a frame on the safety glasses. The hearing protectors attach to the safety glasses via a rubber stem, string, or other fastening means.

This application is based on the invention disclosure filed under the Document Disclosure Program on Jan. 19, 2001, disclosure number 487439.

This application did not receive federal funding for research and development.

### BACKGROUND OF THE INVENTION

The present invention relates generally to protective devices that are worn on the head of a user. More particularly, the present invention relates to a protective device for protecting the sight and hearing of a user.

It is known that high levels of sound can damage auditory nerves. In fact, loud continuous or steadily recurring sounds cause loss of hearing. In response to this knowledge, numerous types of hearing protectors have been manufactured. Several of these hearing protectors include a band that fits over the head of the user and has hearing protection attached at each end thereof. However, many hearing protectors are small earplugs inserted into the ear canal of the user to reduce the amount of sound that enters the ear. Because these earplugs are small, they are easily lost.

It is common place for an individual to misplace earplugs when on the work site. Typically, workers carry several sets of foam earplugs in their pockets to replace misplaced or lost ones. The loss of earplugs becomes costly over time. Furthermore, a worker is apt to proceed with work in noisy conditions if replacement earplugs are not handy, thereby risking injury to hearing.

Many industrial and construction workers must wear eye protection or safety glasses to protect their eyesight. Fling debris, dust or other materials that comes into contact with an eye can scratch the surface of the eye and damage an individual's eyesight. Thus, many industrial and construction workers wear safety glasses to preserve and protect their eyesight.

In many industrial workplaces or construction work sites, governmental regulations require workers to carry both eye and hearing protection. Fines may be levied against companies that do not enforce the regulations by requiring the workers to carry the hearing and sight protectors.

### SUMMARY OF THE INVENTION

The present invention provides a combination sight and hearing protection. Safety glasses are equipped with earplugs affixed or tethered to a wing or frame portion of the safety glasses. The wing of the safety glasses is also referred to as a temple portion. When a wearer removes the safety glasses, the earplugs are also removed. Since the earplugs are coupled to the safety glasses, it is much harder to lose the earplugs.

In one embodiment of the invention, the earplugs are permanently attached to the temple portion of the safety glasses frame. In another embodiment, the earplugs are removably attached to the temple portion.

An attachment member tethers the earplugs to the safety glasses. In the preferred embodiment, the attachment member may include either a flexible rubber stem or a nylon cord or string. The attachment member may also include a loop for removably attaching the earplugs to the frame of the safety glasses.

Typically, the earplug is a resilient and compressible body that conforms to an ear canal of the user. However, other types of earplugs may be used so long as they are capable of reducing harmful noise levels that enter the ear canal.

The safety glasses include protection for the eyes in the form of lenses and side shields. The lenses may include a corrective factor, if necessary. The side shields prevent flying objects from coming in contact with the wearer's eyes from the side.

It is an object of the invention to provide a combination sight and hearing protection device that solves all of the aforementioned problems.

It is another object of the invention to provide a device that prevents the loss of earplugs.

The embodiments of the present invention presented hereinafter are exemplary of the invention. The present invention may be embodied in various configurations. It is to be understood that the specific structural and functional details disclosed in the following embodiments are not to be interpreted as limiting, rather they are the basis for the claims and are to be used to teach a skilled artisan of the art how to practice and use the invention.

### BRIEF DESCRIPTION OF THE DRAWINGS

FIG. 1 is a perspective view of a first embodiment of the invention.

FIG. 2 is a side view of the first embodiment of the invention.

FIG. 3 is a perspective view of a second embodiment of the invention.

### DETAILED DESCRIPTION OF THE INVENTION

It is to be understood that the invention is not limited to the exact construction illustrated and described herein, but that various changes and modifications may be made without departing from the spirit and the scope of the invention as defined in the claims presented at the end of the detailed description.

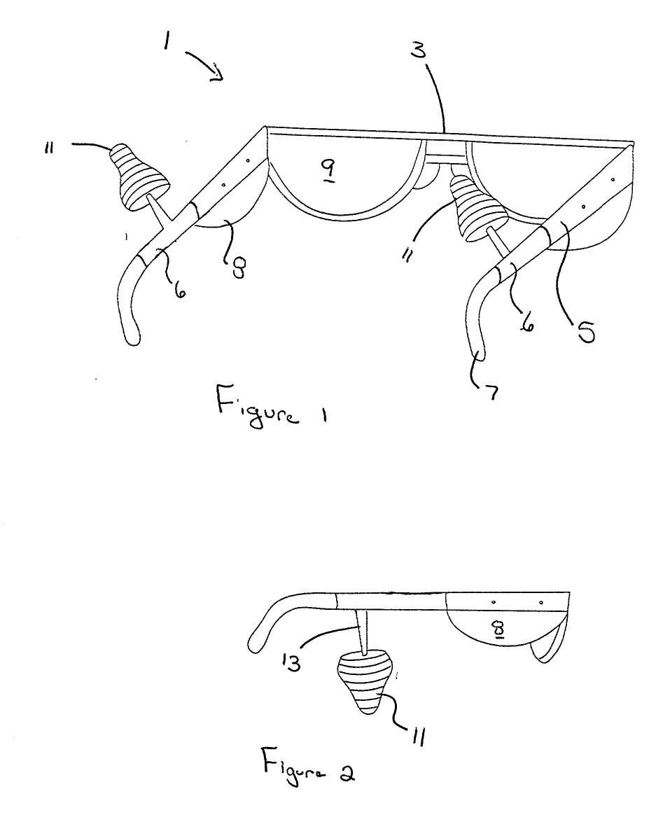

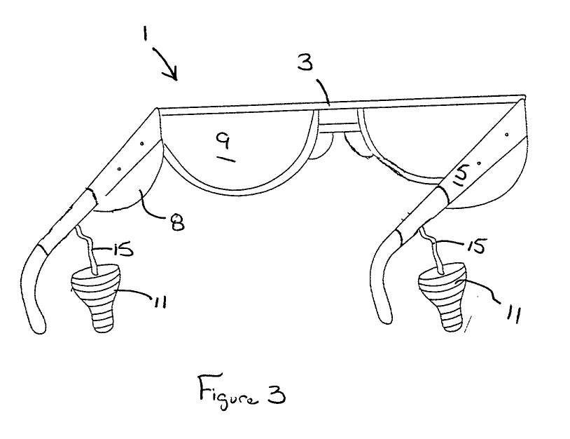

In FIGS. 1 and 2, the combination safety glasses and earplugs device 1 comprises safety glasses 3. The safety glasses 3 typically include shatter resistive lenses 9. Side shields 8 are affixed to temple portion 5 for deflecting or preventing flying debris from hitting the eye of the wearer from the side. It should be noted that the invention might be implemented with a single wrap-style lens or a goggle-shaped lens.

In FIG. 1, an earplug 11 attaches to the temple portion 5 via a flexible rubber stem 13. The rubber stem 13 connects to a rubber sleeve 6. The rubber sleeve 6 is rotatable about temple portion 5. Thus, the earplugs 11 may be readily held away from the ear or ear region of a wearer when the earplugs 11 are not inserted into wearer's ears. Earplugs that dangle from the glasses frame may be considered distracting by some users. The aforementioned types of users therefore prefer this embodiment.

In an alternative embodiment, the rubber sleeve 6 is removable from the temple portion 5. The rubber sleeve 6 includes an expansive ability such that it can be slid onto and off the temple portion 5 via the earpiece 7. The expansive ability of the rubber sleeve 6 facilitates a user in replacing a damaged earplug. Thus when an earplug becomes dirty or damaged, the user can readily replace the earplug with another.

In FIG. 3, the earplugs 11 are attached to the temple portions 5 via a cord or string 15. One end of a cord or string 15 is permanently attached to an earplug 11. An opposite end of the cord or string 15 may include a loop for securing the earplugs 11 to the temple portion 5. Alternatively, the temple portion 5 or earpiece 7 may include a hole through which the cord or string 15 is passed. A knot may be tied at the end of the cord or string 15 to prevent it from passing back through the hole.

It is to be understood that the invention is not limited to the exact construction illustrated and described above. Various changes and modifications may be made without departing from the spirit and the scope of the invention as defined in the following claims.

I claim:

1. A combination sight and hearing protection assembly comprising:
safety glasses including at least one lens for protecting eyes of a user and having a temple portion attached to an earpiece;
a tether attached at one end to one of said temple portion or said ear portion of said safety glasses; and,
an ear plug comprised of a compressible body having a first end for being inserted into an ear canal of a user and a second end permanently affixed to an end of said tether opposite the end attached to one of said temple portion or said ear piece of said safety glasses.

2. The combination sight and hearing protection assembly of claim 1 wherein said tether is a flexible rubber stem.

3. The combination sight and hearing protection assembly of claim 2 wherein said flexible rubber stem includes a rubber sleeve.

4. The combination sight and hearing protection assembly of claim 3 wherein said flexible rubber stem is affixed to said temple portion of said safety glasses and is rotatable around said temple portion.

5. The combination sight and hearing protection assembly of claim 2 wherein said tether is a string.

6. The combination sight and hearing protection assembly of claim 1 wherein said temple portion includes at least one hole for receiving said tether.

7. The combination sight and hearing protection assembly of claim 1 wherein said earpiece includes at least one hole for receiving said tether.

8. A combination sight and hearing protection assembly comprising:
safety glasses for protecting eyes of a user, said safety glasses comprising at least a lens and a frame portion, said frame portion including a temple piece and an ear piece;
a flexible rubber stem attached at one end to one of said temple piece or said ear piece; and,
an earplug attached at one end to said flexible rubber stem.

9. The combination sight and hearing protection assembly of claim 8, wherein said ear plug comprises a compressible body having a first end for being inserted into an ear canal of a user and a second end affixed to said flexible rubber stem.

10. The combination sight and hearing protection assembly comprising:
safety glasses for protecting eyes of a user, said safety glasses comprising at least a lens and a frame portion, said frame portion including a temple piece and an ear piece;
a flexible tether attached at one end to one of said temple piece or said ear piece; and,
an earplug attached at one end to said flexible rubber stem.

11. The combination sight and hearing protection assembly of claim 10 wherein said flexible tether is a string.

12. The combination sight and hearing protection assembly of claim 10 wherein one of said temple piece and said ear piece includes a hole through which said tether passes.

13. The combination sight and hearing protection assembly of claim 10 wherein said tether includes a knot.

14. The combination sight and hearing protection assembly of claim 10 wherein said tether includes a loop.
